(19) United States
(12) Patent Application Publication
(10) Pub. No.: US 2004/0209530 A1
(43) Pub. Date: Oct. 21, 2004

(54) Terminal pin structure and method for manufacturing the same

(76) Inventor: Wen-Hao Hsu, Lu Chou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/842,577

(22) Filed: May 11, 2004

Related U.S. Application Data
(63) Continuation-in-part of application No. 10/353,997, filed on Jan. 30, 2003.

(51) Int. Cl. H01R 9/24

(52) U.S. Cl. 439/885

(57) ABSTRACT

A method for manufacturing includes steps described after. To make a plurality of metallic wires that are rolled in advance by a wire rolling tool into straight lines and to crimp the metallic wires. The metallic wires are penetrated through a round-profiled cutting machine to insert into a housing. To adjust a location of the housing and to regulate a predetermined length of each of the metallic wires. The metallic wires are cut by the round-profiled cutting machine according to the respective predetermined length as a plurality of terminals. The housing that accommodates with the terminals is ejected finally. The opposing distal end portion of the terminal is formed into a contoured profile to provide improved solderability thereby.

### CROSS-REFERENCE TO RELATED APPLICATIONS

This Application is a Continuation-in-Part of application Ser. No. 10/353,997, filed Jan. 30, 2003, and entitled TERMINAL PIN.

### BACKGROUND OF THE INVENTION

1. Field of the Invention

The present invention relates to a terminal pin structure, and particularly relates to a terminal pin structure and a method for manufacturing the same.

2. Background of the Invention

A conventional terminal pin is formed either by soldering and then cutting, or by cutting and then soldering. Means of a flat-profiled cutting machine is provided for cutting the conventional terminal pin. The terminal pin after cutting process has a planar cross-sectional distal end portion thereby. In the first processing way, a solder layer that is electro-plated over the distal end portion of the terminal pin in advance is removed from the planar cross-sectional surface thereof, so as to expose the planar cross-sectional surface of the terminal pin to the atmosphere and have been oxidized. The failure of a solderability test in compliance with the standard IEC68-2-69 happens to the planar cross-sectional surface of the terminal pin, which is performed after an aging test according to the standard EAI364-52. The poor solderability occurs due to natural oxidization to the bare, planar cross-sectional surface of the terminal pin. Alternatively, in the second processing way, every conventional terminal pin that is cut first and then soldered will make more electro-plated steps.

In application aspect of the conventional terminal pin, the terminal pin that is straight and not bent will adopts for insertion and connection to a PCB in a through-hole technology; the terminal pin that is bent with a right angle as an L shape can be mounted to the PCB with a surface mount technology (SMT).

In spite of whether a wire or a lead frame is soldered before and after cut alternatively, the “neat”, “bare”, cross-sectional surface of the terminal pin is subject to the following soldering failure modes. First, the planar cross-sectional surface of the terminal pin cut after soldering process exposes directly to the atmosphere, so as to oxidize easily. That causes deterioration of the solderability and thus to shorten the service life of the terminal pin. Second, an excessive duration of the electro-plated process results in a solder icicle formed on the planar cross-sectional surface of the terminal pin. If the peak portion of the solder icicle is so long, that it requires an additional cutting process to shorten it. Third, an insufficient duration of the electro-plated process results in non-uniform of solder covered on the planar cross-sectional surface of the terminal pin, so that hazards of exposedness and oxidization of the planar cross-sectional surface of the terminal pin will be provided.

Thereafter, during a wave-soldering process or an IR reflow process, the planar cross-sectional surface of the terminal pin in each of the soldering failure modes is hard to be mounted on the PCB due to possibilities of tapered solder icicle or non-uniform of solder thereof, particularly in the surface mounting process.

Referring to FIGS. 1 to 3, the conventional terminal pin structure connected to a coil of a transformer is illustrated. A conventional terminal pin assembly 60 includes a housing 61, a plurality of pin fasteners 62 arranged on the housing 61, and a plurality of terminal pins 63 having respective ends accommodating with the corresponding pin fasteners 62. The housing 61 is I-shaped in horizontal cross-section. Each of the terminal pins 63 has an opposing distal end portion being a cross-sectional surface 64. And a cross-sectional surface 64 is formed by a flat-profiled cutting machine 65. If the duration of electro-plated process is not sufficient, the cross-sectional surface 64 of the terminal pin 63 provides insufficient protection due to a non-uniform solder layer covered thereon. If the duration of electro-plated process is excessive, the tapered solder icicle 66 is formed thereby.

The non-uniform of the solder results in oxidation of the cross-sectional surface 64 of the terminal pin structure 63 and deteriorates the solderability thereof, so as to cause non-wetting or dewetting. If the solder icicle 66 is formed on the cross-sectional surface 64, this latter must undergo an additional cutting step to shorten the unwanted, redundant portion of the solder icicle 66.

Hence, an improvement over the prior art is required to overcome the disadvantages thereof.

### SUMMARY OF INVENTION

The primary object of the invention is therefore to specify a terminal pin structure processed with a manufacturing method that can increase the solderability thereof and avoid the dewetting or non-wetting failure modes, no matter which process of the cutting and soldering process will be provided first.

The secondary object of the invention is therefore to specify a manufacturing method for making a terminal pin structure that provides a pin terminal formation process by a round-profiled cutting machine.

According to the invention, these objects are achieved by a method for manufacturing a terminal pin structure is provided. The method includes steps described after. To make a plurality of metallic wires that are rolled in advance by a wire rolling tool into straight lines and to crimp the metallic wires. The metallic wires are penetrated through a round-profiled cutting machine to insert into a housing. To adjust a location of the housing and to regulate a predetermined length of each of the metallic wires. The metallic wires are cut by the round-profiled cutting machine according to the respective predetermined length as a plurality of terminals. The housing that accommodates with the terminals is ejected finally. And these objects are achieved by a terminal pin structure is provided. The terminal pin structure manufactured by the method includes a column-shaped housing including a pin fastener, a first end portion mounted in a corresponding pin fastener, and an opposing second end portion away from the pin fastener, the second end portion being pulled by a wire rolling tool and cut by a round-profiled cutting machine to be smaller in cross section than the firsts end portion for insertion through or surface mounting on a printed circuit board (PCB).

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a conventional terminal pin structure;

FIG. 2 is a side view of a conventional terminal pin structure during cutting by means of a cutting machine;

FIG. 3 is a side view of a conventional terminal pin structure;

FIG. 4 is a flow chart of a method manufacturing a terminal pin structure according to the present invention;

FIG. 5 is a perspective view of the method manufacturing the terminal pin structure according to the present invention;

FIG. 6 is a perspective view of a terminal pin structure manufactured by the method of an embodiment according to the present invention;

FIG. 7 is a side view of the terminal pin structure during cutting by means of a cutting machine according to one embodiment of the present invention;

FIG. 8 is a perspective view of the terminal pin structure during cutting by means of a round-profiled cutting machine according to the present invention;

FIG. 9 is a side view illustrating the terminal pin structure mounted in a PCB according to the present invention;

FIG. 10 is a side view illustrating the terminal pin structure ready to be mounted in a PCB according to the present invention;

FIG. 11 is a perspective view of the terminal pin structure of another embodiment according to the present invention; and

FIG. 12 is a perspective view of the terminal pin structure of another embodiment according to the present invention.

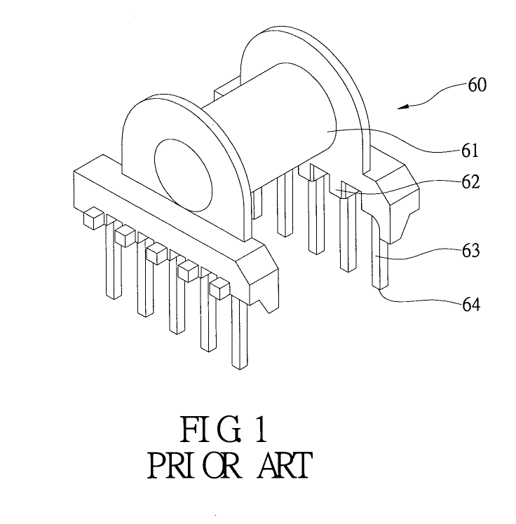

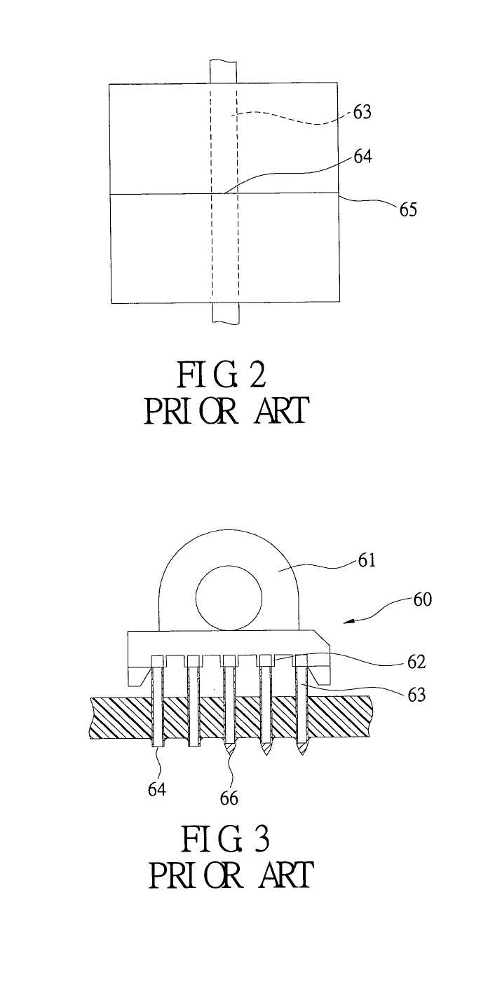

### DETAILED DESCRIPTION OF THE EMBODIMENTS

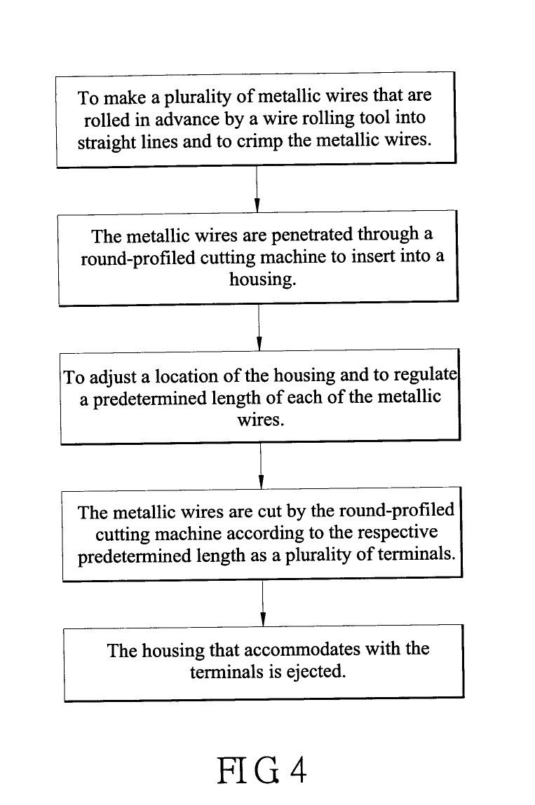

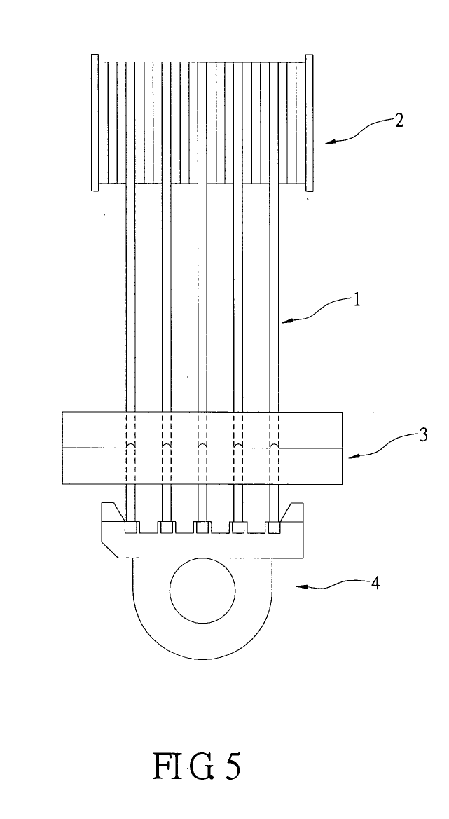

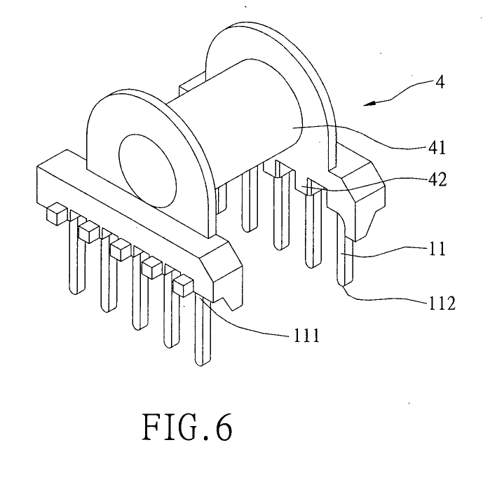

Referring to FIGS. 4 and 5, the present invention provides a method for manufacturing a terminal pin structure. The method includes steps described after. To make a plurality of metallic wires 1 that are rolled in advance by a wire rolling tool 2 into straight lines and to crimp the metallic wires 1. The metallic wires 1 are penetrated through a round-profiled cutting machine 3 to insert into a housing 41. To adjust a location of the housing 41 and to regulate a predetermined length of each of the metallic wires 1. The metallic wires 1 are cut by the round-profiled cutting machine 3 according to the respective predetermined length as a plurality of terminals 11. The housing 41 that accommodates with the terminals 11 is ejected finally. In the step of cutting the metallic wires 1, each of the metallic wires 1 has an end pulled by the rolling tool 2 and an opposing end secured to the housing 41, so as to present extension capacities of the terminals 11. As a common sense, the terminals 11 formed from the metallic wires 1 will extend downwards and to narrow to form a tip thereby. If the metallic wires 1 are soldered in advance, so that each of the terminals 11 remains a soldering layer 13 will be carried and deformed to cover on a cutting surface thereof due to the excellent extension capacities thereof and deformation of the cutting surface thereof.

The present invention provides a terminal pin structure 4 including a housing 41, a plurality of pin fasteners 42, and a plurality of terminals 11 each having a distal end portion 112. The housing 41 is I-shaped in cross-section. Each of the pin fasteners 42 is a raised portion on a bottom of the housing 11 for respectively mounting a corresponding terminal 11. Each of the terminals 11 has a column-shaped housing. Each of the terminals 11 has a first end portion 111 mounted in respective pin fastener 42. The opposing distal end portion 112 of each terminal 11 is shaped and may be rounded by a round-profiled cutting machine 3.

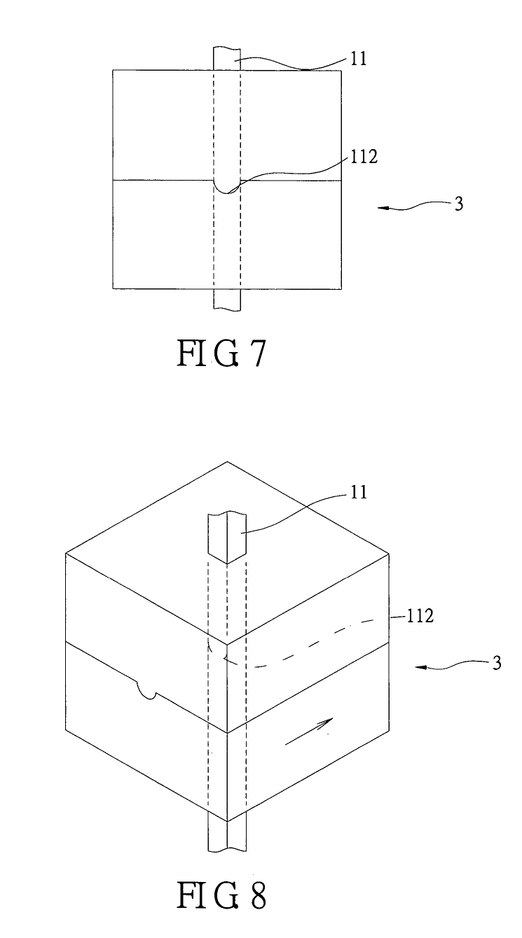

Referring to FIG. 7, the terminals 11 are inserted through the PCB 5. The rounded contour of the distal end portion 112 at the tip of the terminal 11 helps insertion of the respective terminal 11 through the PCB 5.

Referring to FIG. 8, the terminals 11 are surface mounted to the PCB 5. A clearance 51 is formed between each round distal end portion 112 and the PCB 5 for solder pastes of the second end portion 112 to be filled.

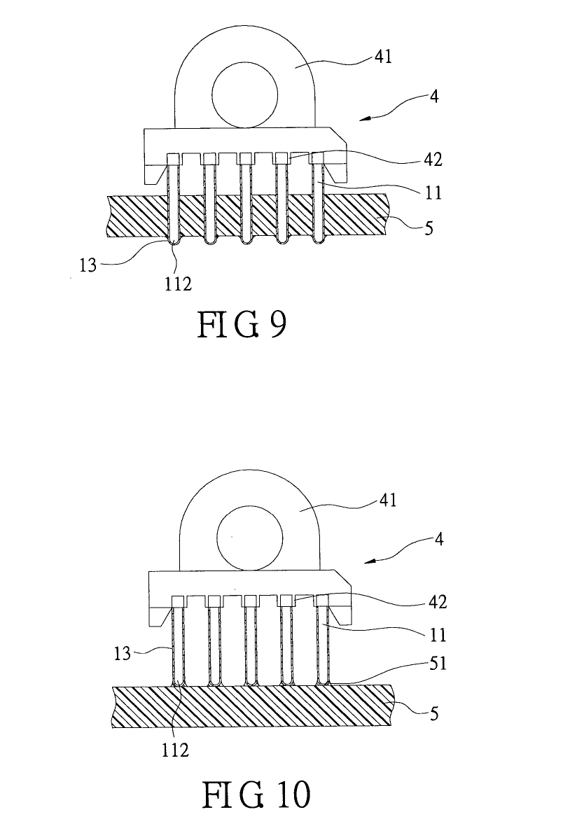

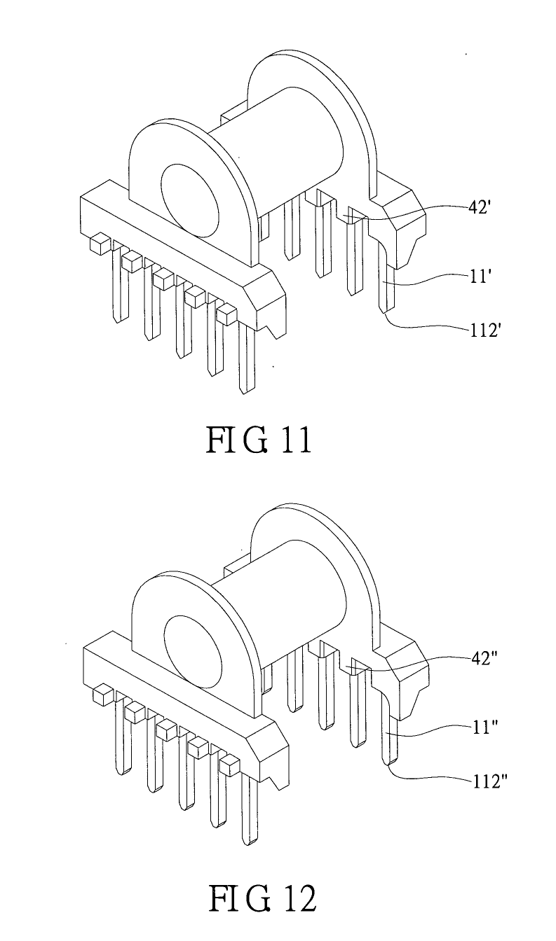

Referring to FIG. 9 which illustrates another embodiment according to the present invention, a distal end portion 112′ is mounted in a pin fastener 42′, and the opposing distal end portion 112′ thereof has a tapered contour.

Referring to FIG. 10, which illustrates another variant embodiment o according to the present invention,, a distal end portion 112″ is mounted in a pin fastener 42′″, and the opposing distal end portion 112′″ thereof has a polygonal contoured

The terminal pin structure of the present invention is characterized in that the terminal is cut by the round-profiled cutting machine and is pulled by the wire rolling tool 2, so that the cutting surface of the terminal is blanketed by the solder.

By means of the cutting and rolling by the contoured cutting machine, the distal end portion of the terminal is formed into a contoured profile, such as rounded, tapered or polygonal profiles, to provide an improved solderability and avoid the solder icicle. Furthermore, the contoured profiles of the distal end portion of the terminal are advantageous to bonding to the PCB, performed by insertion or surface mounting.

With the invention, the prior art problems, such as poor bonding to the PCB caused by the oxidation of the cross-sectional surface of the terminal pin and the demand of a further cutting step for shortening the excessive solder on the cross-sectional surface of the terminal pin, are thereby overcome.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method for manufacturing a terminal pin structure, comprising:
making a plurality of metallic wires that are rolled in advance by a wire rolling tool into straight lines and crimping the metallic wires;
penetrating the metallic wires through a round-profiled cutting machine to insert into a housing;
adjusting a location of the housing to regulate a predetermined length of each of the metallic wires;
cutting the metallic wires by the round-profiled cutting machine according to the respective predetermined length as a plurality of terminals; and
ejecting the housing that accommodates with the terminals.

2. The method of claim 1, in the step of cutting the metallic wires, each of the metallic wires has an end pulled by the rolling tool and an opposing end secured to the housing, so as to present extension capacities of the terminals.

3. The method of claim 2, wherein the metallic wires are soldered in advance, so that each of the terminals remains a soldering layer covered on a cutting surface thereof.

4. A terminal pin structure manufactured by the method as claimed in the claim 1, comprising a column-shaped housing including a pin fastener, a first end portion mounted in a corresponding pin fastener, and an opposing second end portion away from the pin fastener, the second end portion being pulled by a wire rolling tool and cut by a round-profiled cutting machine to be smaller in cross section than the firsts end portion for insertion through or surface mounting on a printed circuit board (PCB).

5. The terminal pin structure of claim 1, wherein the second end portion has a soldering layer covered thereon.

6. The terminal pin structure of claim 1, wherein the second end portion has a rounded profile.

7. The terminal pin structure of claim 1, wherein the second end portion has a tapered profile.

8. The terminal pin structure of claim 1, wherein the second end portion has a polygonal profile.
